(19) United States
(12) Patent Application Publication
(10) Pub. No.: US 2024/0195706 A1
(43) Pub. Date: Jun. 13, 2024

(54) NETWORK MANAGEMENT APPARATUS, NETWORK MANAGEMENT METHOD AND NETWORK MANAGEMENT SYSTEM

(71) Applicant: RAKUTEN MOBILE, INC., Tokyo (JP)

(72) Inventors: Tomomi KANAI, Tokyo (JP); Hiroyuki JO, Tokyo (JP); Rion KIMURA, Tokyo (JP)

(73) Assignee: RAKUTEN MOBILE, INC., Tokyo (JP)

(21) Appl. No.: 17/788,970

(22) PCT Filed: Aug. 4, 2021
(86) PCT No.: PCT/JP2021/028947

§ 371 Date: Jun. 24, 2022

(51) Int. Cl. H04L 41/40; H04L 41/0604; H04L 41/22

(52) U.S. Cl. CPC H04L 41/40; H04L 41/0627; H04L 41/22

(57) ABSTRACT

To enhance efficiency in handing over network resources in a large-scale network, disclosed herein is a network management apparatus, comprising: an environmental information acquisition unit configured to acquire environmental information on a network resource serving as a management target; an analysis unit configured to analyze a handover status of management of the management target from an upstream process to a downstream process based on the environmental information acquired by the environmental information acquisition unit; and a visualization unit configured to visualize the handover status based on an analysis result by the analysis unit.

### TECHNICAL FIELD

The present invention relates to a network management apparatus, a network management method, and a network management system, and in particular to a technique for enhancing efficiency in handing over management targets in a mobile network.

### BACKGROUND ART

With a background of improved performance of general-purpose servers and network infrastructures, cloud computing (hereinafter simply referred to as “cloud”), which on demand uses computing resources that are virtualized on physical resources such as servers, has become widely prevailing. In addition, the Network Function Virtualization (NFV), which virtualizes network functions and provides the virtualized network functions on the cloud, has been well known. The NFV is a technology that uses virtualization and cloud technologies to separate the hardware and software of various network services, which used to run on dedicated hardware, and to run the software on a virtualized infrastructure. It is expected to improve the sophistication of operations and reduce costs by use of those virtualization technologies.

In recent years, the virtualization has been advanced in mobile networks as well.

Patent Literature 1 discloses, in order to migrate virtual machines safely and reliably in the NFV environment constituting the mobile network, a technique to determine whether or not the virtual machines can be migrated based on predetermined determination criteria, and then to perform the virtual machine migration processing when it is determined to migrate the virtual machines. More particularly, the disclosed technique is designed to define the determination criteria between the OSS/BSS (Operation Support System/Business Support System) and the orchestrator to determine whether or not to migrate the virtual machines, and using the virtual machine migration availability status management table, the migration availability status is managed by mapping the migration availability status of each virtual machine to each virtual machine ID. The orchestrator receives a virtual machine migration request from the VIM (Virtualized Infrastructure Manager) and determines whether or not to migrate the virtual machine based on the virtual machine migration availability status management table.

### LISTING OF REFERENCES

### Patent Literature

PATENT LITERATURE 1: International Publication of PCT International Patent Application No. WO2015/146374 A

### SUMMARY OF THE INVENTION

### Problems to be Solved by the Invention

In large-scale networks such as mobile networks, there are often separate departments (or persons or companies) each of which is in charge of different process of a series of processes, such as construction, operation, and maintenance of the network, and thus it is required to enhance efficiency in handing over between departments. For example, after the construction department constructs the network, the management of the network is required to be handed over to the operation department expeditiously.

Conventionally, although the status of each of network resources has been managed as in the technique disclosed in Patent Literature 1 above, the status of handover of management targets between departments has been managed using a management chart or the like manually entered by the person in charge of each of departments. However, in a large-scale network, there are a large number of network resources to be managed and a large number of items to be checked as well when handing over each of the network resources. Manually performed status management is a highly time-consuming task, and it is impractical to manually input every detail of the status. As a result, in many cases the handover status of individual management target is likely to be unclear.

When the handover status of management targets is unclear, it leads to delays in locating where the handover process is stalled and delays in dealing with the causes thereof, and also it takes considerable time to completely hand over the management target. In addition, the lack of clarity about the management department in charge may lead to increase in communication costs, for example, when a certain problem occurs, the wrong department may be requested to analyze the problem.

The present invention has been made in order to solve the above mentioned problems and an object thereof is to provide a network management apparatus, a network management method, and a network management system capable of enhancing efficiency in handing over network resources in a large-scale network.

### Solution to Problems

In order to solve the above mentioned problems, according to one aspect of the present invention, there is provided a network management apparatus, comprising: an environmental information acquisition unit configured to acquire environmental information on a network resource serving as a management target; an analysis unit configured to analyze a handover status of management of the management target from an upstream process to a downstream process based on the environmental information acquired by the environmental information acquisition unit; and a visualization unit configured to visualize the handover status based on an analysis result by the analysis unit.

The management target may be a virtualization infrastructure constituting a network, and the analysis unit may analyze the handover status in units of accommodating stations each accommodating a plurality of servers constituting the virtualization infrastructure.

The analysis unit may analyze the handover status by determining whether or not predetermined handover criteria are met based on the environmental information acquired by the environmental information acquisition unit.

The analysis unit may analyze the handover status using the handover criteria each defined with respect to the management target.

The environmental information acquisition unit may acquire, as the environmental information on the management target, information on an occurrence status of an alert issued when a failure occurs and information on an implementation status of an acceptance test; and the analysis unit may determine that the handover criteria are met when no alerts have been issued for a certain period of time and a result of the acceptance test is normal.

The visualization unit may display the handover status analyzed by the analysis unit to be in any one of a handover-ready state, a handover-fixed state, and a handover-unfixed state.

When the handover status analyzed by the analysis unit is in the handover-fixed state, the visualization unit may display a scheduled date of the fixed handover.

When the handover status analyzed by the analysis unit is in the handover-unfixed state, the visualization unit may display a cause for stalling a handover process.

The upstream process may correspond to a construction process and the downstream process may correspond to an operation process.

According to another aspect of the present invention, there is provided a network management method performed by a network management apparatus, comprising steps of: acquiring environmental information on a network resource serving as a management target; analyzing a handover status of management of the management target from an upstream process to a downstream process based on the environmental information; and visualizing the handover status based on an analysis result.

According to yet another aspect of the present invention, there is provided network management system, comprising: an environmental information acquisition unit configured to acquire environmental information on a network resource serving as a management target; an analysis unit configured to analyze a handover status of management of the management target from an upstream process to a downstream process based on the environmental information acquired by the environmental information acquisition unit; and a visualization unit configured to visualize the handover status based on an analysis result by the analysis unit.

### Advantageous Effect of the Invention

According to the present invention, it makes it possible to enhance efficiency in handing over network resources in a large-scale network.

The above mentioned and other not explicitly mentioned objects, aspects and advantages of the present invention will become apparent to those skilled in the art from the following embodiments (detailed description) of the invention by referring to the accompanying drawings and the appended claims.

### BRIEF DESCRIPTION OF DRAWINGS

FIG. 1 is a conceptual diagram illustrating an exemplary network configuration of a mobile network including a network management apparatus according to the present embodiment of the present invention.

FIG. 2 is a block diagram illustrating an exemplary internal configuration of a network management system.

FIG. 3 is a block diagram illustrating an exemplary functional configuration of a handover status management section according to the present embodiment.

FIG. 4 is a schematic diagram illustrating an exemplary acceptance test.

FIG. 5 is a schematic diagram illustrating an exemplary display of the handover status.

FIG. 6 is a schematic diagram illustrating another exemplary display of the handover status.

FIG. 7 is a schematic diagram illustrating an exemplary display of causes of unfixed handover.

FIG. K is a schematic diagram illustrating yet another exemplary display of the handover status.

### DESCRIPTION OF EMBODIMENTS

Hereinafter, embodiments of the present invention will be described in detail with reference to the accompanying drawings. Among the constituent elements disclosed herein, those having the same function are denoted by the same reference numerals, and a description thereof is omitted. It should be noted that the embodiments disclosed herein are illustrative examples as means for implementing the present invention, and should be appropriately modified or changed depending on a configuration and various conditions of an apparatus to which the present invention is applied, and the present invention is not limited to the following embodiments. Furthermore, it should be noted that all of the combinations of features described in the following embodiments are not necessarily essential to the solution of the present invention.

Hereinafter, a non-limiting example will be described in which a network management apparatus according to the present embodiment has a handover status management function that manages a handover status of a network resource, which is a management target in a mobile network constructed on a virtualization infrastructure.

More particularly, the network management apparatus analyzes the handover status of management of the management target from an upstream process to a downstream process based on environmental information on the network resource, which is the management target, and visualizes the handover status based on the analysis results. Here, the upstream process corresponds to, for example, a construction process, and the downstream process corresponds to, for example, an operation process. The management target corresponds to, for example, the virtualization infrastructure that constitutes the mobile network.

It should be note that, although the following description describes an example of the handover of management from the construction process to the operation process, the upstream and downstream processes may correspond to, for example, an upper and lower processes into which the construction process is further subdivided.

The management target is not limited to the virtualization infrastructure, but may include, for example, network devices (switches, routers, and the like) and applications that constitute the mobile network.

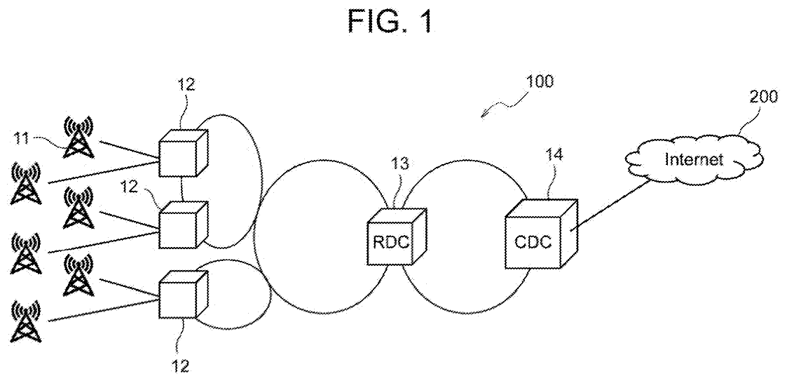

FIG. 1 is a conceptual diagram illustrating an exemplary network configuration of a mobile network 100 including a network management apparatus according to the present embodiment.

In the mobile network 100 shown in FIG. 1, a mobile communicable terminal such as a smartphone and the Radio Access Network (RAN) communicate with each other wirelessly, and the transmitted information is relayed through the backhaul network (i.e., Mobile Backhaul: MBH) to the core network for processing. This allows the mobile communicable terminal to connect to the Internet 200 or connect to another company's network to make voice calls, or the like.

More particularly, the mobile network 100 includes base stations 11 and a plurality of accommodating stations 12 to 14. In FIG. 1, the accommodating station 12 is an edge data center, the accommodating station 13 is a Regional Data Center (RDC), and the accommodating station 14 is a Central Data Center (CDC). A backhaul network is constituted between the edge data center 12 and the central data center 14.

The mobile network 100 according to the present embodiment is a virtualized network constructed on a virtualization infrastructure. The mobile network 100 realizes everything from the switching equipment of the backbone network to the radio access functions of the base stations by software on general-purpose servers.

The base station 11 is equipped with an antenna, a switchboard, a battery, and the like.

The edge data center 12 is located near the base stations 11 and is connected to a plurality of base stations 11 via fiber-optic cables, or the like. The edge data center 12 realizes the RAN-related radio access functions.

The regional data center 13 is connected to a plurality of edge data centers 12. The regional data center 13 realizes, by software, the firewall/NAT (Network Address Translation), the CDN (Content Distribution Network), and various applications for edge computing.

The central data center 14 is connected to a plurality of regional data centers 13. The central data center 14 realizes core functions such as the EPC (Evolved Packet Core), the IMS (IP Multimedia Subsystem), or the like.

It should be noted that the number of respective data centers (i.e., accommodating stations), that is, the edge data center 12, the regional data center 13, and the central data center 14, is not limited to the number shown in FIG. 1. For example, although only one regional data center 13 and one central data center 14 are shown in FIG. 1, there may be a plurality of regional data centers 13 and central data centers 14, respectively.

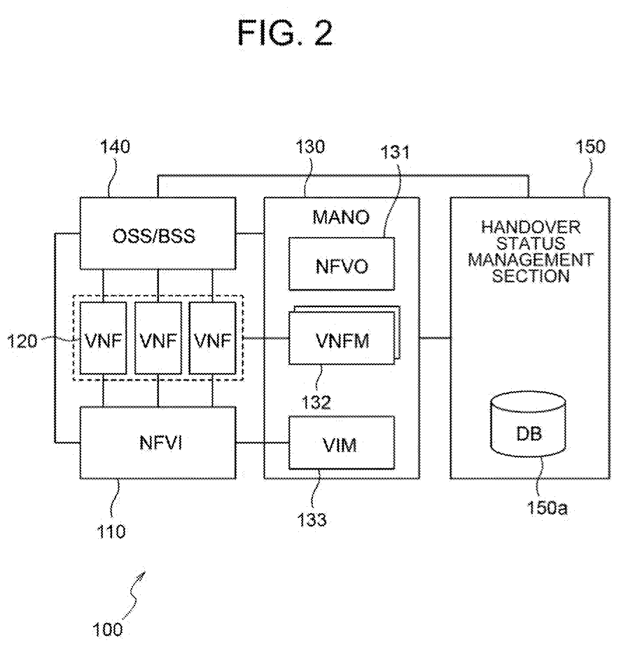

FIG. 2 is a block diagram illustrating an exemplary internal configuration of a network management system that constitutes the mobile network 100.

Each of constituent elements shown in FIG. 2 has a reference point. The lines connecting the constituent components shown in FIG. 2 indicate that connected constituent elements via the line can send and receive information from each other.

The NFVI (NFV Infrastructure) 110 is a network function virtualization infrastructure, and includes physical resources, a virtualization layer, and virtualized resources. The physical resources include hardware resources such as computing resources, storage resources, and transmission resources. The virtualization layer is a virtualizing layer such as a hypervisor for virtualizing the physical resources and providing the virtualized physical resources to the VNF (Network Function Virtualization) 120. The virtualized resources are the virtualized infrastructure resources provided to the VNF 120.

In other words, the NFVI 110 is an infrastructure that enables flexible handling of hardware resources of physical servers (hereinafter also simply referred to as “servers”), such as computing, storage, and network functions, as virtualized hardware resources such as virtualized computing, virtualized storage, and virtualized network, which are virtualized by the virtualization layer such as the hypervisor.

A plurality of servers that constitute the NFVI 110 are grouped together and deployed in each of the data centers 12 to 14. The number, the placement positions, wiring, and the like, of the servers to be deployed in each of the data centers 12 to 14 are predetermined depending on the type of data center (i.e., accommodating station type). In each of the data centers 12 to 14, the deployed servers are connected by an internal network and are capable of sending and receiving information from each other. In addition, the data centers are connected to each other by a network, and the servers in different data centers are capable of sending and receiving information from each other via the network.

The VNF 120 corresponds to applications running on virtual machines (VMs) on the servers and implements the network functions by software. Although not specifically shown, each VNF 120 may be provided with a management function called an EM (Element Manager).

The NFVI 110 and the VNF 120 in FIG. 2 constitute the virtualized environment. In other words, the virtualized environment is constituted with three layers, in order from the lower layer: the hardware, the virtualization layer, and virtual machines.

The MANO (Management and Orchestration) 130 has management and orchestration functions for the virtualized environment. The MANO 130 includes the NFVO (NFV-Orchestrator) 131, the VNFM (VNF-Manager) 132, and the VIM (Virtualized Infrastructure Manager) 133.

The NFVO 131 orchestrates the NFVI resources, manages the lifecycle of network services, and provides integrated operational management of the entire system. The NFVO 131 is capable of performing processing in response to instructions from the OSS/BSS (Operation Support System/Business Support System) 140, which will be described below.

The VNFM 132 manages the lifecycle of each of the VNFs 120. It should be noted that the VNFM 132 may be arranged in the MANO 130 as a dedicated VNFM corresponding to each of VNFs 120. Alternatively, a single VNFM 132 may manage the lifecycle of two or more VNFs 120. In this case, the VNFM 132 may be a general-purpose VNFM that supports VNFs 120 provided by different vendors.

The VIM 133 performs operational management of the resources of the VNFs 120.

The OSS/BSS 140 is an integrated management system for the mobile network 100.

Here, the OSS is a system (i.e., equipment, software, mechanism, and the like) necessary for constructing and operating the desired services, and the BSS is an information system (i.e., equipment, software, mechanism, and the like) used for billing, invoicing, and customer services.

The handover status management section 150 realizes a handover status management function in which the handover status management section 150 acquires environmental information on the management target, analyzes the handover status of management of the management target from the upstream process to the downstream process based on the acquired environmental information, and visualizes the analyzed handover status. The handover status management section 150 constitutes the network management apparatus according to the present embodiment.

The handover status management section 150 is equipped with a handover status management database (DB) 150a that manages the handover status of the management targets. The handover status management section 150 updates the handover status management database 150a according to the analysis results of the handover status based on the acquired environmental information.

According to the present embodiment, the handover status management database 150a manages the handover status in units of the accommodating stations, each of which accommodate a plurality of servers that constitute the virtualization infrastructure, respectively. Hereinafter, a certain case will be described in which the handover status is managed for each of the edge data centers 12. In the following description, the edge data center is referred to as a GC (Group unit Center).

It should be noted that the unit for managing the handover status is not limited to a GC unit, but may be set as appropriate depending on the management target. For example, the management status may be managed in units of servers, in units of racks each accommodating a plurality of servers, or in units of regions each including a plurality of accommodating stations.

The handover status management database 150a correlates identification information on a GC to the handover status of the GC and manages the correlated GC identification information and GC handover status. The GC identification information includes the GC ID.

The handover status may be classified into the following three states: “handover-ready state,” which indicates that the handover is ready or available from the upstream process to the downstream process (i.e., tasks necessary for handing over have been completed); “handover-fixed state,” which indicates that the scheduled date is fixed for handing over from the it upstream process to the downstream process; and “handover-unfixed state,” which indicates that the scheduled date is not yet fixed for handing over from the upstream process to the downstream process.

The handover status management database 150a may also include attribute information on the GC. Here, the attribute information on the GC may include the area where the GC is installed (“Area”), the GC name (“GC Name”), and the BBU (Base Band Unit) type (“BBU Type”), and the like.

Furthermore, the handover status management database 150a may include attribute information on the handover status. The attribute information on the handover status may include information used to analyze the handover status (such as a log), the scheduled handover date when the handover status is in the handover-fixed state, and the cause for stalling the handover process when the handover status is in the handover-unfixed state.

It also should be noted that the handover status management section 150 is not limited to being an external function of the OSS/BSS 140 or the MANO 130 as shown in FIG. 2. The handover status management section 150 may be provided inside the OSS/BSS 140 or alternatively inside the MANO 130. In this case, the handover status management function of the handover status management section 150 is a part of the functions of the OSS/BSS 140 or the MANO 130.

Although the present embodiment describes a certain case in which the handover status management section 150 is equipped with the handover status management database 150a, alternatively, the handover status management database 150a may be provided by an external device. In this case, the handover status management section 150 sends the analysis results of the handover status to the external device, and the external device updates the handover status management database 150a based on the received analysis results. Subsequently, the handover status management section 150 refers to the handover status management database 150a provided by the external device, and visualizes the handover status, which is updated by the external device.

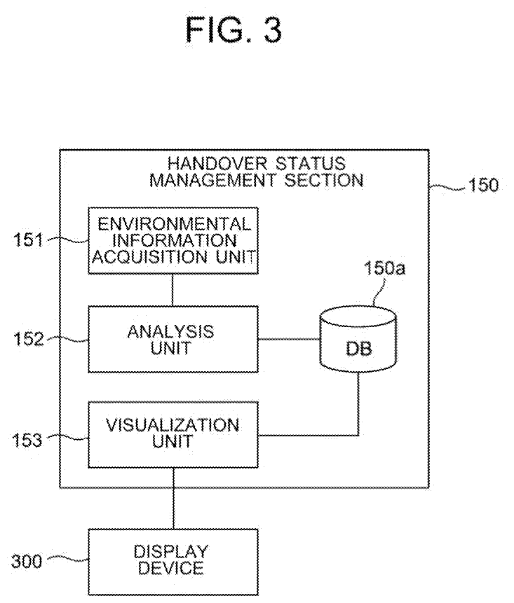

FIG. 3 is a block diagram illustrating an exemplary functional configuration of the handover status management section 150.

As shown in this FIG. 3, the handover status management section 150 includes an environmental information acquisition unit 151, an analysis unit 152, and a visualization unit 153.

The environment information acquisition unit 151 acquires the environment information on the virtualization infrastructure, which serves as the management target. The above environmental information may include information on an occurrence status of an alert issued when a failure occurs and information on an implementation status of the acceptance test.

Here, the above alert includes an error, a warning, and a notice. The information on the implementation status of the acceptance test includes information indicating whether or not the acceptance test has been completed and the results of the acceptance test (e.g., results of the normality check).

The mobile network 100 according to the present embodiment is a virtualized network constructed on the virtualization infrastructure. The virtualized environment constituting the mobile network 100 is constituted with stacked layers, from hardware to applications. More particularly, the servers that constitute the virtualized environment are realized in a hierarchical structure in which the hardware, the host OS, the virtualization layer software (i.e., virtualization infrastructure), and the applications (i.e., telecom applications) software are all stacked in this order. In this way, when a certain kind of failure occurs in the network implemented in the above multi-layer structure, an alert notifying of the failure will be notified corresponding to a layer in which the failure has occurred.

The environmental information acquisition unit 151 acquires the above occurrence status of the alert as the environmental information.

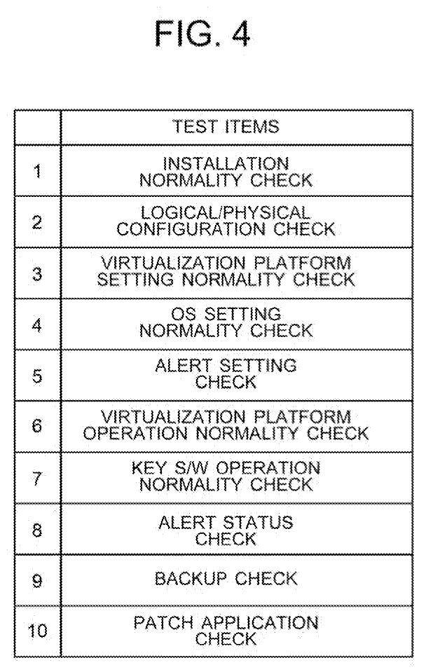

FIG. 4 is a schematic diagram illustrating an exemplary acceptance test in the construction process of constructing the virtualization infrastructure. The acceptance test shown in FIG. 4 is a test to verity and confirm that the software running on the physical servers constituting the virtualization infrastructure is operating correctly.

A first check item, “installation normality check,” is to confirm that the installation of the virtualization platform software has been completed normally.

A second check item, “logical/physical configuration check,” is to confirm that the intended software is normally installed on the intended hardware.

A third check item, “virtualization platform setting normality check,” is to confirm that the configuration information, setting information, and credentials (i.e., information used for authentication such as accounts and passwords) of the virtualization platform software are correct

A fourth check item, “OS setting normality check,” is to confirm that the logs of middleware, which provides the functions necessary for automatic installation of the OS, indicates normal.

A fifth check item, “alert setting check,” is to confirm that the alert definitions are set up correctly.

A sixth check item. “virtualization platform operation normality check,” is to confirm that respective software and processes that constitute the virtualization platform are operating normally.

A seventh check item, “key software operation normality check,” is to confirm that the key software of the virtualization platform is operating normally.

An eighth check item, “alert status check,” is to confirm whether or not the alert has been detected.

A ninth check item, “backup check,” is to confirm that backups of the virtualization platform software have been obtained correctly.

A tenth check item, “patch application check,” is to confirm that the necessary patches have been applied.

The environmental information acquisition unit 151 acquires the implementation status of the above described acceptance test as the environmental information. It should be noted that the actual contents of the acceptance test may be set up as appropriate according to the management target, and are not limited to the ten check items shown in FIG. 4.

The analysis unit 152 analyzes the handover status by determining whether or not the predetermined handover criteria are met based on the environmental information acquired by the environmental information acquisition unit 151. The handover criteria may be defined respectively with respect to the management target.

For example, the analysis unit 152 may determine that the handover criteria are met when no alerts have been issued for a certain period of time (e.g., 7 days) and when the results of the acceptance test are found normal. When the handover criteria are determined to be met, the analysis unit 152 determines the GC concerned to be in the handover-ready state, and updates the handover status management database 150a.

It should be noted that, when the handover conditions are determined to be met and the GC concerned is in the handover-ready state, contact information on the department in charge of the downstream process (or a person or company in charge, or the like) may be notified that the GC concerned becomes ready to be handed over.

The visualization unit 153 visualizes and displays, on the display device 300, the handover status of the management target analyzed by the analysis unit 152 in any one of the handover-ready state, the handover-fixed state, and the handover-unfixed state. The display device 300 may be a terminal device that is operable by an administrator in charge of the construction, operation, maintenance, or the like, of the mobile network 100.

The visualization unit 153 is capable of displaying the handover status, for example, in units of GCs. At this time, the visualization unit 153 may allow the logs of the acceptance test to be browsed on the display device along with the handover status.

When the handover status analyzed by the analysis unit 152 is in the “handover-fixed state”, the visualization unit 153 may display the scheduled date of the handover, which has been already fixed, on the display device 300. The analysis unit 152 may automatically set the scheduled date of the handover by estimating the period of time until the handover criteria are met based on the occurrence status of the alert and the implementation status of the acceptance test, or alternatively, a person in charge of the upstream process may specify the scheduled date of the handover.

When the handover status analyzed by the analysis unit 152 is in the “handover-unfixed state”, the visualization unit 153 may display the cause for stalling the handover process on the display unit 300. The analysis unit 152 may automatically set the cause for stalling the handover process by predicting the cause for stalling the handover process based on the contents of the notified alert or the logs of the acceptance test, or alternatively, a person in charge of the upstream process may specify the cause for stalling the handover process.

Furthermore, the visualization unit 153 may also display the department in charge of the management target at that time based on the handover status. In this case, the visualization unit 153 may display not only the name of the department in charge but also the contact information on the department in charge. The department in charge above may be the person or company in charge. In the following description, the term “department” is assumed to include the person or company in charge as well.

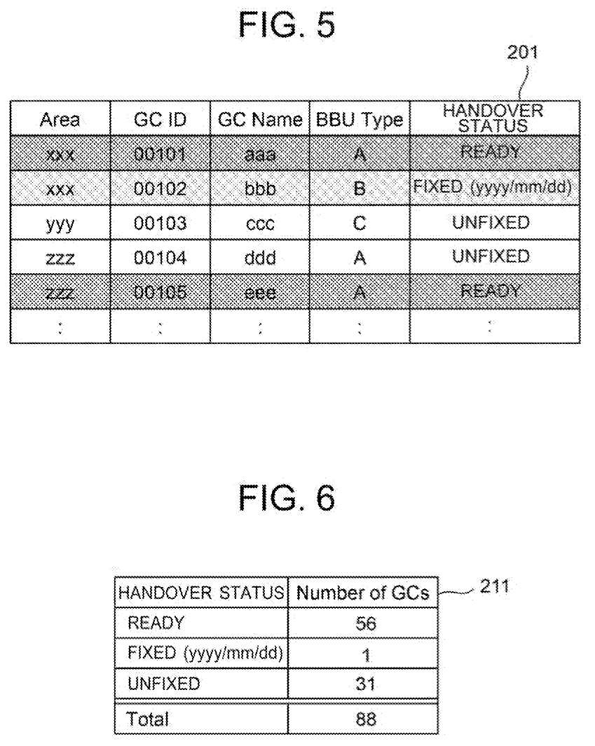

The visualization unit 153 may list the handover statuses, for example, as shown in a table 201 in FIG. 5, along with the identification information on GCs and the attribute information on GCs.

Here, the handover state “ready” indicates that the handover status is in the handover-ready state. The handover state “fixed” indicates that the handover status is in the handover-fixed state, and the date (yyyy/mm/dd) following the “fixed” state indicates the scheduled data of the handover. Likewise, the handover state “unfixed” indicates that the handover status is in the handover-unfixed state.

At this time, the colors displayed may be different for each of handover statuses such that the overall handover statuses can be figured out easily and visually.

It should be noted that the information to be displayed along with the handover status is not limited to the information shown in the table 201 in FIG. 5. For example, links may be displayed to enable browsing of information used to analyze the handover status (e.g., acceptance test logs or the like) and the causes for stalling the handover process in case of the handover-unfixed state.

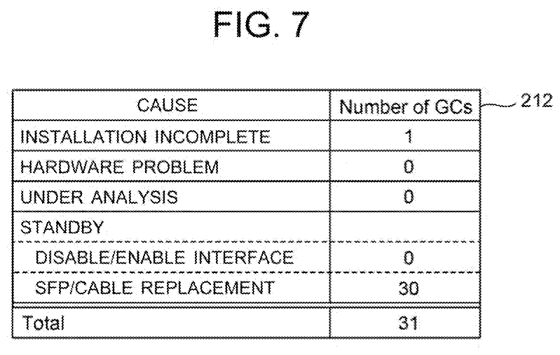

The visualization unit 153 may also tally the overall handover statuses to display the tallied handover statuses, for example, as shown in a table 211 in FIG. 6. In this case, it makes it possible to easily figure out the number of GCs that have not yet completed the handover.

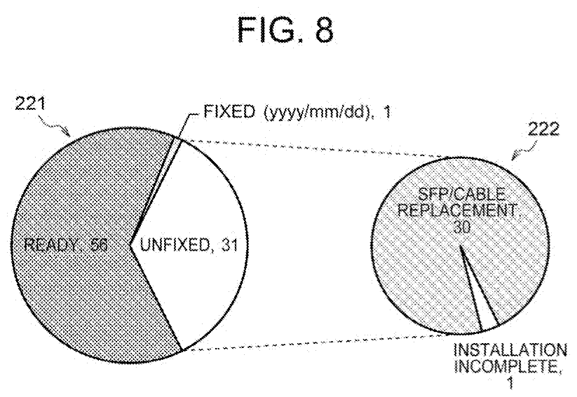

It should be noted that the table 211 in FIG. 6 may display links to enable browsing of the causes for stalling the handover process in case of the handover-unfixed state. In this case, the link destination may display the tallied causes for stalling the handover process in aggregate, for example, as shown in a table 212 in FIG. 7.

In addition, as shown in a graph 221 in FIG. 7, the visualization unit 153 may visualize, for example, the overall handover statuses by making and displaying a pie chart thereof. Likewise, as shown in another graph 222 in FIG. 7, the visualization unit 153 may visualize the causes for stalling the handover process in case of the handover-unfixed state.

It should be noted that the specifics of displaying the handover status is not limited to the above, but other display methods may be employed. A person browsing the handover status may also be able to select the display method.

It should be also noted that the configuration of the functional blocks of the handover status management section 150 shown in FIG. 3 is no more than exemplary, and multiple functional blocks may constitute a single functional block, or any of the functional blocks may be divided into multiple blocks that perform multiple functions.

In addition, the multiple functions of the handover status management section 150 may be divided into the external functions of the OSS/BSS 140 or the MANO 130, and the internal functions of the OSS/BSS 140 or the MANO 130 of the network management system shown in FIG. 2.

As described above, the handover status management section 150, which serves as the network management apparatus according to the present embodiment, acquires the environmental information on the network resource, which serves as the management target, and analyzes the handover status of management of the management target from the upstream process (e.g., construction process) to the downstream process (e.g., operation process) based on the acquired environmental information. Subsequently, the handover status management section 150 visualizes the handover status based on the analysis results of the handover status. Here, the above management target corresponds to a virtualization infrastructure that constitutes a network, and the handover status management section 150 may analyze the handover status in units of accommodation stations, each of which accommodates a plurality of servers that constitute the virtualization infrastructure (e.g., on a GC-by-GC basis).

Accordingly, since the analysis of the handover status can be automated, even when a large number of management targets are to be managed or a large number of check items are to be confirmed when handing over the management targets, it makes it possible to analyze and manage the individual handover statuses expeditiously and appropriately so that it makes it possible to hand over the management of the management target to the operation department after constructing the network by the construction department.

For example, even after the construction is completed by the construction department, when it takes considerable time for the final operational check to determine whether or not the management target is ready for handover to the operation department, the management target is likely to change to a state where handover is not possible due to the environmental change (e.g., occurrence of a problem) during that time. In such cases, additional time is required to analyze and deal with the cause of the failure. By automating the analysis of the handover status, it makes it possible to promptly determine whether or not the management target is ready for handover to perform the handover, thereby reducing the time described above.

Furthermore, it makes it possible to eliminate the need for manual confirmation and status management necessary for handing over, thereby reducing the human costs associated with those processes.

Yet furthermore, the real-time visualization of the handover status of the management of the management target from the construction department to the operation department allows the person in charge of each department to appropriately figure out the status of the individual handover. In other words, it makes it possible for the person in charge to appropriately figure out the current management department of the management target concerned. Therefore, when a problem occurs, the correct department can be requested to analyze the problem. As a result, it makes it possible to expeditiously and appropriately deal with the problem that has occurred. In addition, it makes it possible to avoid the situation where a request for analysis is made to the wrong department so as to reduce the communication costs.

Yet furthermore, based on the acquired environmental information, the handover status management section 150 may determine whether or not the predetermined handover criteria are met, and when the handover criteria are determined to be met, the handover status management section 150 may determine that the management target is ready for being handed over. Here, the handover criteria may be defined as appropriate for each of management targets.

For example, the handover status management section 150 may acquire, as the environmental information on the management target, the information on the occurrence status of alerts issued when a failure occurs and the implementation status of the acceptance test, and when no alerts have been issued for a certain period of time and the results of the acceptance tests are found normal, the handover status management section 150 may determine that the handover criteria are met. As a result, it makes it possible to appropriately analyze whether or not the management target is ready for being handed over from the construction department to the operation department.

Yet furthermore, the handover status management section 150 may indicate, based on the analysis results of the transfer status, the handover status is in any one of the handover-ready state, the handover-fixed state, and the handover-unfixed state on the display device. In this way, by displaying the handover status in a phased manner, it makes it possible to further clarify the handover status.

When the handover status is in the handover-fixed state, the handover status management section 150 may display the scheduled date of the handover, which is fixed. Furthermore, when the handover status is in the handover-unfixed state, the handover status management section 150 may display the cause for stalling the handover process. In this case, it makes it possible to easily figure out the details of the individual handover statuses based on the visualized information. Therefore, it eliminates the need to manually locate and retrieve individual information for confirming the status details. In addition, it makes it possible to easily find out a part of the handover process that are stalled and the cause thereof so as to expeditiously deal with the problem.

As described above, according to the present embodiment, it makes it possible to shorten the time required for handing over the environment and clarify issues in handing over the environment and the management departments in charge. As a result, it makes it possible to enhance efficiency in handing over the network resources in a large-scale network constituted on the virtualization infrastructure.

The network management apparatus according to the present embodiment may be implemented in any of general-purpose servers that constitute the backhaul network, the core network, or the like, of the mobile network 100. Alternatively, the network management apparatus may be implemented in a dedicated server. The network management apparatus may also be implemented on a single or a plurality of computers.

When the network management apparatus is implemented on a single computer, the network management apparatus may include a CPU, a ROM, a RAM, an HDD, an input unit (e.g., keyboard, pointing device, or the like), a display unit (e.g., monitor, or the like), a communication/F, and the like. In this case, at least a part of the functions of the constituent elements of the handover status management section 15) shown in FIG. 3 may be performed by executing the program by the above CPU. However, at least a part of the constituent elements of the handover status management section 150 shown in FIG. 3 may be operated as dedicated hardware. In this case, the dedicated hardware operates based on the control of the above CPU.

Although certain embodiments have been described above, the embodiments described are merely illustrative and are not intended to limit the scope of the present invention. The apparatus and methods described herein may be embodied in other forms than those described above. In addition, without departing from the scope of the present invention, omissions, substitutions, and modifications may be made to the above embodiments as appropriate. Such omissions, substitutions, and modifications fall within the scope of the appended claims and equivalents thereof and fall within the technical scope of the present invention.

### REFERENCE SIGNS LIST

11: Base Station; 12: Edge Data Center; 13: Regional Data Center; 14: Central Data Center; 100: Mobile Network; 110: NFVI: 120: VNF; 130: MANO; 131: NFVO; 132: VNFM; 133: VIM; 140: OSS/BSS; 150: Handover Status Management Section; 151: Environmental Information Acquisition Unit; 152: Analysis Unit; 153: Visualization Unit

1. A network management apparatus, comprising:
at least one memory configured to store program code; and
electronic circuitry including at least one processor, the at least one processor being configured to read and operate according to the program code to:
acquire environmental information on a network resource serving as a management target;
analyze a handover status of management of the management target from an upstream process to a downstream process based on the environmental information; and
visualize the handover status based on an analysis result.

2. The network management apparatus according to claim 1, wherein:
the management target is a virtualization infrastructure constituting a network, and the at least one processor is further configured to read and operate according to the program code to analyze the handover status in units of accommodating stations each accommodating a plurality of servers constituting the virtualization infrastructure.

3. The network management apparatus according to claim 1, wherein the at least one processor is further configured to read and operate according to the program code to:
analyze the handover status by determining whether or not predetermined handover criteria are met based on the environmental information.

4. The network management apparatus according to claim 3, wherein the at least one processor is further configured to read and operate according to the program code to:
analyze the handover status using the handover criteria each defined with respect to the management target.

5. The network management apparatus according to claim 3, wherein the at least one processor is further configured to read and operate according to the program code to:
acquire, as the environmental information on the management target, information on an occurrence status of an alert issued when a failure occurs and information on an implementation status of an acceptance test; and
determine that the handover criteria are met when no alerts have been issued for a certain period of time and a result of the acceptance test is normal.

6. The network management apparatus according to claim 1, wherein the at least one processor is further configured to read and operate according to the program code to:
display the handover status to be in any one of a handover-ready state, a handover-fixed state, and a handover-unfixed state.

7. The network management apparatus according to claim 6, wherein the at least one processor is further configured to read and operate according to the program code to:
when the handover status is in the handover-fixed state, display a scheduled date of the fixed handover.

8. The network management apparatus according to claim 6, wherein the at least one processor is further configured to read and operate according to the program code to:
when the handover status is in the handover-unfixed state, display a cause for stalling a handover process.

9. The network management apparatus according to claim 1, wherein
the upstream process corresponds to a construction process and the downstream process corresponds to an operation process.

10. A network management method performed by a network management apparatus, comprising steps of:
acquiring environmental information on a network resource serving as a management target;
analyzing a handover status of management of the management target from an upstream process to a downstream process based on the environmental information; and
visualizing the handover status based on an analysis result.

11. A network management system, comprising:
at least one memory configured to store program code; and
electronic circuitry including at least one processor, the at least one processor being configured to read and operate according to the program code to:
acquire environmental information on a network resource serving as a management target;
analyze a handover status of management of the management target from an upstream process to a downstream process based on the environmental information; and
visualize the handover status based on an analysis result.
